(19) United States
(12) Patent Application Publication
(10) Pub. No.: US 2023/0081764 A1
(43) Pub. Date: Mar. 16, 2023

(54) ULTRASONIC TREE MEASUREMENT SYSTEM

(71) Applicant: TOPCON POSITIONING SYSTEMS, INC., Livermore, CA (US)

(72) Inventors: Kevin S. CROWE, Saskatoon (CA); Yuzhe (Solomon) OUYANG, Saskatoon (CA); James SCHNAIDER, Martensville (CA)

(73) Assignee: TOPCON POSITIONING SYSTEMS, INC., Livermore, CA (US)

(21) Appl. No.: 17/931,555

(22) Filed: Sep. 13, 2022

Related U.S. Application Data
(60) Provisional application No. 63/261,197, filed on Sep. 14, 2021.

(51) Int. Cl. G01S 7/539; G01S 7/52; G01S 15/04; G01S 15/42; G01S 15/86

(52) U.S. Cl. CPC G01S 7/539; G01S 7/52036; G01S 15/04; G01S 15/42; G01S 15/86

(57) ABSTRACT

Systems and methods for calculating a plant spread and a plant density of vegetation are provided. An ultrasonic signal is transmitted towards vegetation by one or more transducers. A plurality of echo signals is received as reflections of the ultrasonic signal by the one or more transducers. A plant spread of the vegetation is calculated based on a first echo signal of the plurality of echo signals and a last echo signal of the plurality of echo signals. A plant density of the vegetation is calculated based on the plurality of echo signals. The plant spread and the plant density of the vegetation are output.

This application claims the benefit of U.S. Provisional Application No. 63/261,197, filed Sep. 14, 2021, the disclosure of which is herein incorporated by reference in its entirety.

### TECHNICAL FIELD

The present invention relates generally to a tree measurement system, and in particular to an ultrasonic tree measurement system for measuring the plant spread and plant density of vegetation.

### BACKGROUND

A sprayer is an agricultural machine used to apply liquids, such as, e.g., herbicides, pesticides, fertilizers, and water, to vegetation. In one example, a sprayer is utilized in grape vineyards to apply such liquids to grape vine trees. In order to provide the optimal amount of liquid to the grape vine trees, the spread and density of the grape vine trees need to be determined.

Traditional measurements of grape vine trees are limited to measurements of the tree envelope (canopy), typically using LIDAR (light detection and ranging) sensors or basic ultrasonic sensors. However, measurements describing the interior composition or tree depth of the grape vine trees are not captured by such traditional measurements.

Other methods exist to measure the entire volume of the grape vine trees but require sensor measurements from both sides of the tree row, which is a more time consuming and less-efficient process. Scanning from both sides requires driving down both sides of the grape vine tree or supporting sensors on either side of the grape vine tree. If measurements made from either side of the grape vine tree are used to calculate the tree width, a common frame of reference for position is required, such as high-accuracy GPS (global positioning system) positioning (which may introduce errors).

### BRIEF SUMMARY OF THE INVENTION

In accordance with one or more embodiments, systems and methods for calculating a plant spread and a plant density of vegetation are provided. An ultrasonic signal is transmitted towards vegetation by one or more transducers. A plurality of echo signals is received as reflections of the ultrasonic signal by the one or more transducers. A plant spread of the vegetation is calculated based on a first echo signal of the plurality of echo signals and a last echo signal of the plurality of echo signals. A plant density of the vegetation is calculated based on the plurality of echo signals. The plant spread and the plant density of the vegetation are output.

In one embodiment, the plurality of echo signals is received within a time window. The plant density of the vegetation may be calculated based on a quantity of the plurality of echo signals received during the time window or based on a strength of the plurality of echo signals received during the time window. The plant spread may be calculated by calculating a first distance between the transducer and the vegetation based on the first echo signal and calculating a second distance between the transducer and the vegetation based on the last echo signal. The plant spread is determined as a difference between the first distance and the second distance.

In one embodiment, particular echo signals of the plurality of echo signals are detected that are associated with one or more non-vegetation structures based on at least one of 1) a distance determined based on the particular echo signals or 2) a strength of the particular echo signals. The particular echo signals are removed from the plurality of echo signals.

In one embodiment, a map of the vegetation is generated based on at least one of the plant spread or the plant density using GPS (global positioning system) data.

In one embodiment, a substance is applied to the vegetation at a variable rate determined in substantially real time based on at least one of the plant spread or the plant density.

In one embodiment, the plurality of echo signals is normalized based on a distance between the one or more transducers and the vegetation.

In one embodiment, the one or more transducers are mounted on an agricultural machine.

These and other advantages of the invention will be apparent to those of ordinary skill in the art by reference to the following detailed description and the accompanying drawings.

### BRIEF DESCRIPTION OF THE DRAWINGS

FIG. 1 shows an illustrative agricultural site in which a tree measurement system may measure the plant spread and plant density of vegetation, in accordance with one or more embodiments;

FIG. 2 shows vegetation on which a tree measurement system may measure the plant spread and plant density, in accordance with one or more embodiments;

FIG. 3 shows a schematic diagram of an illustrative agricultural machine, in accordance with one or more embodiments; and

FIG. 4 shows a method for determining a plant spread and plant density of vegetation, in accordance with one or more embodiments.

### DETAILED DESCRIPTION

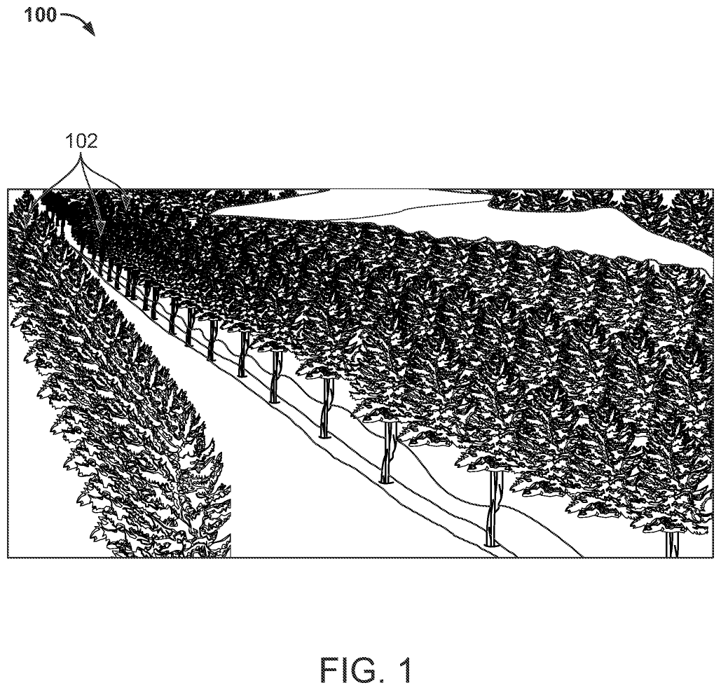

Embodiments described herein provide for a tree measurement system comprising one or more ultrasonic sensors for estimating one or both of the plant spread and the plant density of vegetation (e.g., a vine row) at an agricultural site. One example of an agricultural site is shown in FIG. 1.

FIG. 1 shows an agricultural site 100 in which a tree measurement system may measure the plant spread and plant density of vegetation, in accordance with one or more embodiments. As shown in FIG. 1, agricultural site 100 is a grape vineyard comprising rows 102 of grape vine trees. However, agricultural site 100 may be any agricultural site comprising any suitable type of vegetation (e.g., apple trees, tomato plants, etc.). In accordance with one embodiment, a tree measurement system may be configured for measuring the plant spread and/or plant density of rows 102 of grape vine trees.

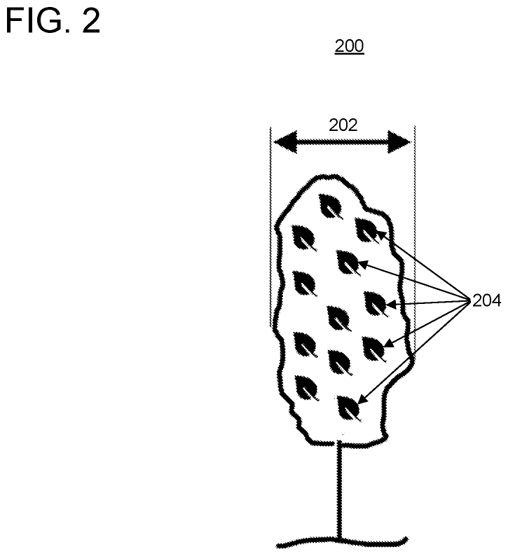

FIG. 2 shows vegetation 200 on which a tree measurement system may measure the plant spread and plant density, in accordance with one or more embodiments. The plant spread refers to a measure of lateral width of the vegetation. For example, as shown in FIG. 2, the plant spread may represent a distance 202 of the lateral width of vegetation 200. Plant density refers to a measure of an amount of plant material (e.g., leaves, branches, fruit) between the plant spread. For example, the plant density may represent the amount of plant material 204 within distanced 202.

The tree measurement system comprises one or more ultrasonic sensors or transducers for transmitting an ultrasonic signal to a particular row of vegetation and receiving a plurality of echo signals reflecting from the ultrasonic signal for determining the plant spread and the plant density of the row of vegetation. The time of arrival and signal strength information for each echo signal is recorded. The echo signals are reflections of the ultrasonic signal from, e.g., foliage, branches, and other tree material (and potentially non-tree material) of the row of vegetation. The information collected by the ultrasonic sensor may be used to describe, for example (but not limited to), the plant spread and plant density, as well as any other suitable metric, such as, e.g., the distance to the tree envelope. The plant spread may be quantified based on the first echo signal and the last echo signal received during a time window. The plant density may be quantified based on the number of reflected echo signals received during the time window or the amount or strength of the reflected signals' energy received during the time window.

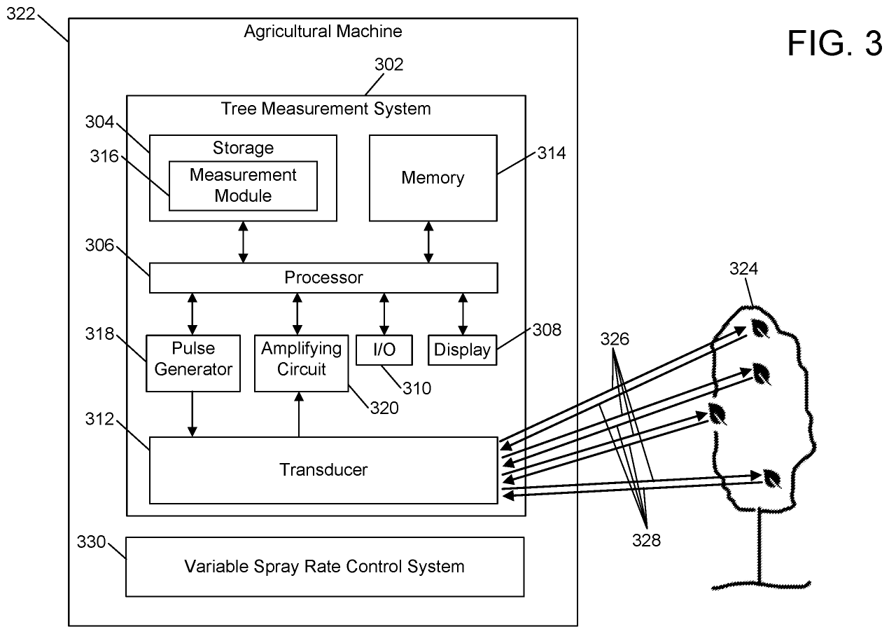

In one embodiment, the tree measurement system may be implemented on an agricultural machine. For example, the tree measurement system may be implemented on a sprayer to provide information to a variable rate spray control system for varying the real-time application rate of a liquid based on the amount of tree material detected. An exemplary agricultural machine is represented in FIG. 3.

FIG. 3 shows a schematic diagram of an illustrative agricultural machine 322 comprising a tree measurement system 302 for measuring a plant spread and plant density of vegetation 324, in accordance with one or more embodiments. In one embodiment, agricultural machine 322 is a sprayer. However, agricultural machine 322 may be any other suitable agricultural machine. In one example, vegetation 324 comprises rows 102 of grape vine trees of FIG. 1 or vegetation 200 of FIG. 2. However, vegetation 324 may comprise any other type of vegetation.

Tree measurement system 302 may include one or more processors 306 communicatively coupled to memory 314, storage 304, display device 308, and input/output devices 310. Storage 304 may store a plurality of modules representing functionality of tree measurement system 302. In one embodiment, storage 304 stores a measurement module 316 for measuring plant spread, plant density, and other metrics of vegetation 324. Each of the modules may be implemented as computer program instructions (e.g., code) stored in storage 304, which may be loaded into memory 314 and executed by processor 306 when execution of the computer program instructions is desired.

In operation, measurement module 316 operates in transmit-and-receive cycles. During the transmit phase, processor 306 instructs pulse generator 318 to generate an electrical signal, which is converted to a single ultrasonic signal 326 (represented as separate signals to illustrate processing of vegetative material) and transmitted towards vegetation 324 by one or more transducers 312. In one embodiment, transducers 312 transmit ultrasonic signal 326 towards a side of vegetation 324 (e.g., a side of a grape vine tree). In this embodiment, transducers 312 do not transmit ultrasonic signal 326 from the top down towards the top of vegetation 324, which require additional processing. In another embodiment, in addition to transducers 312 transmitting ultrasonic signal 326 towards the side of vegetation 324, an additional transducer may be used to transmit ultrasonic signals from the top down towards the top of vegetation 324, and the reflected signals may be used for determining the plant density or calculating other metrics of interest (e.g., a tree height). As used herein, a transducer refers to a single device for sending and receiving signals, but also refers to a pair of discrete devices, one device for transmitting a signal and the other device for receiving a signal. In one embodiment, the ultrasonic signal 326 is an ultrasonic pulse having a duration of, e.g., approximately 70 milliseconds to 320 microseconds. The radiation pattern of the ultrasonic signal is conical in shape, centered around transducer 312 and expanding radially outward as the ultrasonic signal propagates away from transducer 312. The ultrasonic signal 326 encounters one or more objects (e.g., vegetation 324) and reflects back as a plurality of echo signals 328 of the ultrasonic signals 326.

During the receive phase, a predefined receive window is opened defining a period of time during which the plurality of echo signals 328 of the ultrasonic signal 326 is expected to be received by transducer 312. The receive window may be any suitable length of time to allow echo signals of the ultrasonic signal to be received by transducer 312. For example, the receive window may be 10 milliseconds in duration. Transducer 312 receives the ultrasonic echo signals 328 and converts the ultrasonic echo signals 328 to an electrical signal. The electrical signal is passed to amplifying circuit 320 where the electrical signal is amplified for processing by processor 306. While the plurality of echo signals 328 is represented in FIG. 3 as four echo signals, the plurality of echo signals may comprise any number of echo signals greater than one.

Processor 306 calculates a plant spread and a plant density of vegetation 324. In one embodiment, plant spread of vegetation 324 is determined by calculating a first distance between the transducer and the vegetation based on the first echo signal received during the time window and calculating a second distance between the transducer and the vegetation based on the last echo signal received during the time window. Processor 306 calculates the first and second distances between transducer 312 and vegetation 324 based on the time elapsed between transmitting the ultrasonic signal 326 and receiving the respective echo signal 328. The plant spread of vegetation 324 is then determined as a difference between the first distance and the second distance. In one embodiment, plant density of vegetation 324 is calculated based on a quantity of the plurality of echo signals 328 received during the time window or based on a strength of the plurality of echo signals 328 received during the time window. For example, the plant density of vegetation 324 may be calculated as a summation of the energy of echo signals 328. The energy of an echo signal 328 may be calculated by multiplying the duration of the echo signal by the amplitude of the echo signal. In one embodiment, for each echo signal 328, the amplitude is normalized based on the distance at which it was acquired (for example, with the amplitude inversely proportional to the square of the distance) to account for dispersion of ultrasonic energy of the echo signal through the environment.

In one embodiment, the measurement module 316 continuously operates by repeatedly performing the transmit-and-receive cycle at periodic, discrete intervals. The intervals may be any suitable length of time, such as, e.g., every 15 to 35 milliseconds.

In one embodiment, ultrasonic signal 326 is transmitted and echo signals 328 are received as described in U.S. Pat. No. 8,843,283, entitled “Height Control,” the disclosure of which is incorporated herein by reference in its entirety.

In one embodiment, transducer 312 of tree measurement system 302 comprises a single ultrasonic sensor mounted at the mid-section of row of vegetation 324 for calculating the plant spread and plant density to sufficiently represent vegetation 324. In other embodiments, transducer 312 of tree measurement system 302 comprises more than one ultrasonic sensor. For example, an array of sensors may be arranged to capture information from across the height of the row of vegetation 324. In another example, a sensor array may be used to view two rows of vegetation 324 simultaneously (as the tree measurement system travels between two rows).

In one embodiment, particular echo signals of the plurality of echo signals 328 that are associated with non-vegetation structures may be detected based on a distance determined based on the particular echo signals or a strength of the particular echo signals. An example of a non-vegetation structure includes wire supports, which grape tree vines are typically grown on. Transmission of an ultrasonic signal towards the grape tree vines may result in a particular echo signal reflecting from the wire supports. The particular echo signals may be detected and removed from the plurality of echo signals 328. The particular echo signal corresponding to the non-vegetation structure may be detected based on a known distance of the non-vegetation structure from transducer 312, a known pulse width corresponding to an echo signal reflecting from the non-vegetation structure, and/or a signal amplitude corresponding to an echo signal reflecting from the non-vegetation structure. In one embodiment, the distance, pulse width, and signal amplitude of the particular echo signal corresponding to a wire support may be identified by capturing a baseline ultrasonic scan where the plant spread is substantially zero (or below a threshold distance), which indicates no vegetation is present. The distance, pulse width, and signal amplitude of the echo signal reflecting from the wire support may be captured and used to identify the particular echo signal corresponding to a wire support from the plurality of echo signals 328. The particular echo signal corresponding to the non-vegetation structure can be subtracted from the result. For example, the plurality of echo signals 328 may be digitized (by recording echo distance, echo pulse width, and pulse amplitude). At this point, the non-vegetative structure may be identified from the digitized echo signals (by distance, pulse width, and/or amplitude) and removed from the list of results.

In one embodiment, the tree measurement system 302 may be used to monitor vineyard or tree properties. The plant spread and/or plant density may be combined with GPS (global positioning system) coordinates data to generate maps for agronomic planning purposes

In one embodiment, agricultural machine 322 comprises a variable rate spray control system 330. Tree measurement system 302 may output the plant spread and/or plant density to the variable rate spray control system 330 for varying the real-time application rate of an herbicide, a pesticide, a fertilizer, water, or any other substance (e.g., liquid, granules, or any other product) based on the plant spread and/or the plant density.

Embodiments described herein measure plant spread and plant density based on a plurality of echo signals of an ultrasonic transmission. This is a much more straightforward process than conventional approaches requiring measurements from either side of the row. Conventional IR (infrared) and laser methods are not believed to perform as well in their ability to measure through a tree. Advantageously, embodiments described herein utilize ultrasonic waves, which can diffract and transmit through the tree structure and provide information not possible using light-based methods.

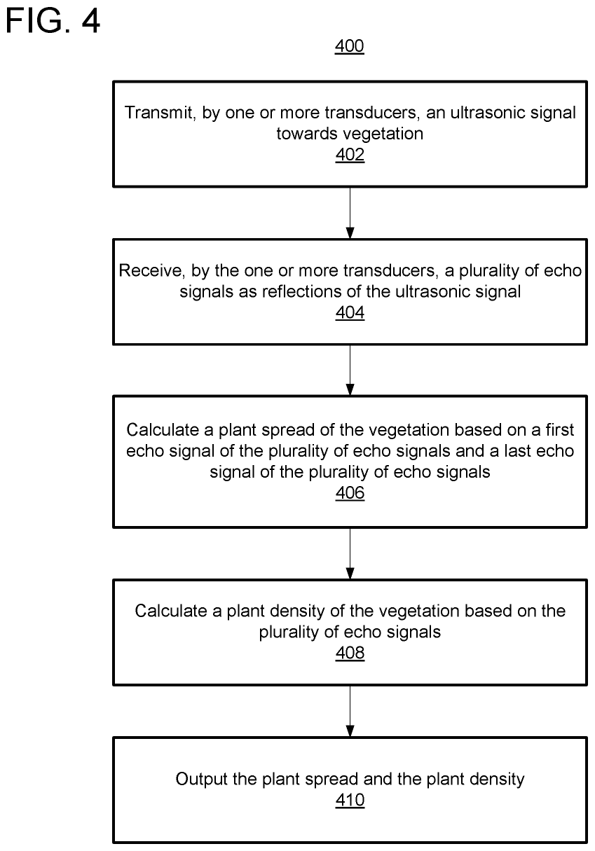

FIG. 4 shows a method 400 for measuring the plant spread and plant density of vegetation, in accordance with one or more embodiments. The steps of method 400 may be performed using one or more suitable computing devices (e.g., using processor 306 of FIG. 3).

At step 402, an ultrasonic signal is transmitted towards vegetation by one or more transducers. The one or more transducers may be transducer 312 of FIG. 3. In one embodiment, the vegetation comprises grape vine trees. However, the vegetation may comprise any other suitable vegetation. The one or more transducers may be mounted or otherwise implemented on an agricultural machine, such as, e.g., a sprayer for spraying or applying a substance (e.g., an herbicide, a pesticide, a fertilizer, or water) to the vegetation.

At step 404, a plurality of echo signals is received by the one or more transducers as reflections of the ultrasonic signal. The plurality of echo signals is received during a time window.

In one embodiment, the plurality of echo signals is normalized based on a distance between the one or more transducers and the vegetation.

In one embodiment, particular echo signals of the plurality of echo signals that are associated with non-vegetation structures (e.g., wire supports) are detected based on at least one of a distance determined based on the particular echo signals or a strength of the particular echo signals. The particular echo signals are removed from the plurality of echo signals.

At step 406, optionally, a plant spread of the vegetation is calculated based on a first echo signal of the plurality of echo signals and a last echo signal of the plurality of echo signals. In one embodiment, the plant spread is calculated by calculating a first distance between the transducer and the vegetation based on the first echo signal received during the time window and calculating a second distance between the transducer and the vegetation based on the last echo signal received during the time window. The plant spread is then determined as a difference between the first distance and the second distance.

At step 408, optionally, a plant density of the vegetation is calculated based on the plurality of echo signals. In one embodiment, the plant density of the vegetation is calculated based on a quantity of the plurality of echo signals received during the time window. In another embodiment, the plant density of the vegetation is calculated based on a strength of the plurality of echo signals received during the time window.

It should be understood that the performance of both step 406 and step 408 in method 400 is not required. Method 400 may be performed by perform step 406 without performing step 408, by performing step 408 without performing step 406, or by performing both step 406 and step 408.

At step 410, the plant spread and the plant density are output. For example, the plant spread and the plant density can be output by displaying the plant spread and the plant density on a display device of a computer system, storing the plant spread and the plant density on a memory or storage of a computer system, or by transmitting the plant spread and the plant density to a remote computer system.

In one embodiment, at least one of the plant spread or the plant density are output to a variable rate spray control system of the agricultural machine. A substance (e.g., an herbicide, a pesticide, a fertilizer, or water) is applied to the vegetation at a variable rate determined in substantially real time based on the at least one of the plant spread or the plant density.

In one embodiment, a map of the vegetation is generated based on at least one of the plant spread or the plant density using GPS data.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps of the methods and workflows described herein. Certain steps of the methods and workflows described herein may be performed by a server or by another processor in a network-based cloud-computing system. Certain steps of the methods and workflows described herein may be performed by a client computer in a network-based cloud computing system. The steps of the methods and workflows described herein may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method and workflow steps described herein may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Tree measurement system 302 of FIG. 3 may comprise a computer to implement systems, apparatus, and methods described herein. Processor 306 controls the overall operation of tree measurement system 302 by executing computer program instructions that define such operations. The computer program instructions may be stored in storage 304, memory 314, or other computer readable medium. Thus, the method and workflow steps described herein, such as, e.g., method 400 of FIG. 4, can be defined by the computer program instructions stored in storage 304 or memory 314 and controlled by processor 306 executing the computer program instructions. For example, the computer program instructions can be implemented as computer executable code programmed by one skilled in the art to perform the method and workflow steps described herein. Accordingly, by executing the computer program instructions, the processor 306 executes the method and workflow steps described herein. Tree measurement system 302 may also include one or more network interfaces (not shown) for communicating with other devices via a network. Tree measurement system 302 may also include one or more input/output (I/O) devices 310 that enable user interaction with the tree measurement system 302 (e.g., display, keyboard, mouse, speakers, buttons, etc.).

Processor 306 may include both general and special purpose microprocessors, and may be the sole processor or one of multiple processors of tree measurement system 302. Processor 306 may include one or more central processing units (CPUs), for example. Processor 306 and/or memory 314 may include, be supplemented by, or incorporated in, one or more application-specific integrated circuits (ASICs) and/or one or more field programmable gate arrays (FPGAs).

Storage 304 and memory 314 may include a tangible non-transitory computer readable storage medium. Storage 304 and memory 314 may include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 310 may include peripherals, such as a printer, scanner, display screen, etc. For example, input/output devices 310 may include a display device such as a cathode ray tube (CRT) or liquid crystal display (LCD) monitor for displaying information to the user, a keyboard, and a pointing device such as a mouse or a trackball by which the user can provide input to tree measurement system 302.

Any or all of the systems and apparatus discussed herein may be implemented using one or more computers such as tree measurement system 302 of FIG. 3.

One skilled in the art will recognize that an implementation of an actual computer or computer system may have other structures and may contain other components as well, and that tree measurement system 302 in FIG. 3 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method comprising:
transmitting, by one or more transducers, an ultrasonic signal towards vegetation;
receiving, by the one or more transducers, a plurality of echo signals as reflections of the ultrasonic signal; and
calculating a plant density of the vegetation based on the plurality of echo signals.

2. The computer-implemented method of claim 1, wherein:
receiving, by the one or more transducers, a plurality of echo signals as reflections of the ultrasonic signal comprises receiving the plurality of echo signals within a time window; and
calculating a plant density of the vegetation based on the plurality of echo signals comprises calculating the plant density of the vegetation based on a quantity of the plurality of echo signals received during the time window.

3. The computer-implemented method of claim 1, wherein:
receiving, by the one or more transducers, a plurality of echo signals as reflections of the ultrasonic signal comprises receiving the plurality of echo signals within a time window; and
calculating a plant density of the vegetation based on the plurality of echo signals comprises calculating the plant density of the vegetation based on a strength of the plurality of echo signals received during the time window.

4. The computer-implemented method of claim 1, wherein receiving, by the one or more transducers, a plurality of echo signals as reflections of the ultrasonic signal comprises receiving the plurality of echo signals within a time window, the computer-implemented method further comprising:
calculating a plant spread of the vegetation based on a first echo signal of the plurality of echo signals received during the time window and a last echo signal of the plurality of echo signals received during the time window.

5. The computer-implemented method of claim 4, wherein calculating a plant spread of the vegetation based on a first echo signal of the plurality of echo signals and a last echo signal of the plurality of echo signals comprises:
calculating a first distance between the one or more transducers and the vegetation based on the first echo signal;
calculating a second distance between the one or more transducers and the vegetation based on the last echo signal; and
determining the plant spread as a difference between the first distance and the second distance.

6. The computer-implemented method of claim 4, further comprising:
generating a map of the vegetation based on at least one of the plant spread or the plant density using GPS (global positioning system) data.

7. The computer-implemented method of claim 4, further comprising:
applying a substance to the vegetation at a variable rate determined in substantially real time based on at least one of the plant spread or the plant density.

8. The computer-implemented method of claim 1, further comprising:
detecting particular echo signals of the plurality of echo signals associated with one or more non-vegetation structures based on at least one of 1) a distance determined based on the particular echo signals or 2) a strength of the particular echo signals; and
removing the particular echo signals from the plurality of echo signals.

9. The computer-implemented method of claim 1, further comprising:
normalizing the plurality of echo signals based on a distance between the one or more transducers and the vegetation.

10. The computer-implemented method of claim 1, wherein the one or more transducers are mounted on an agricultural machine.

11. A non-transitory computer readable medium storing computer program instructions, the computer program instructions when executed by a processor cause the processor to perform operations comprising:
transmitting, by one or more transducers, an ultrasonic signal towards vegetation;
receiving, by the one or more transducers, a plurality of echo signals as reflections of the ultrasonic signal; and
calculating a plant density of the vegetation based on the plurality of echo signals.

12. The non-transitory computer readable medium of claim 11, wherein:
receiving, by the one or more transducers, a plurality of echo signals as reflections of the ultrasonic signal comprises receiving the plurality of echo signals within a time window; and
calculating a plant density of the vegetation based on the plurality of echo signals comprises calculating the plant density of the vegetation based on a quantity of the plurality of echo signals received during the time window.

13. The non-transitory computer readable medium of claim 11, wherein:
receiving, by the one or more transducers, a plurality of echo signals as reflections of the ultrasonic signal comprises receiving the plurality of echo signals within a time window; and
calculating a plant density of the vegetation based on the plurality of echo signals comprises calculating the plant density of the vegetation based on a strength of the plurality of echo signals received during the time window.

14. The non-transitory computer readable medium of claim 11, wherein receiving, by the one or more transducers, a plurality of echo signals as reflections of the ultrasonic signal comprises receiving the plurality of echo signals within a time window, the operations further comprising:
calculating a plant spread of the vegetation based on a first echo signal of the plurality of echo signals received during the time window and a last echo signal of the plurality of echo signals received during the time window.

15. The non-transitory computer readable medium of claim 14, wherein calculating a plant spread of the vegetation based on a first echo signal of the plurality of echo signals and a last echo signal of the plurality of echo signals comprises:
calculating a first distance between the one or more transducers and the vegetation based on the first echo signal;
calculating a second distance between the one or more transducers and the vegetation based on the last echo signal; and
determining the plant spread as a difference between the first distance and the second distance.

16. An apparatus comprising:
one or more transducers for:
transmitting an ultrasonic signal towards vegetation, and
receiving a plurality of echo signals as reflections of the ultrasonic signal;
a processor; and
a memory to store computer program instructions, the computer program instructions when executed on the processor cause the processor to perform operations comprising:
calculating a plant density of the vegetation based on the plurality of echo signals.

17. The apparatus of claim 16, wherein receiving a plurality of echo signals as reflections of the ultrasonic signal comprises receiving the plurality of echo signals within a time window, the operations further comprising:
calculating a plant spread of the vegetation based on a first echo signal of the plurality of echo signals received during the time window and a last echo signal of the plurality of echo signals received during the time window.

18. The apparatus of claim 17, the operations further comprising:
generating a map of the vegetation based on at least one of the plant spread or the plant density using GPS (global positioning system) data.

19. The apparatus of claim 17, the apparatus further comprising:
a variable spray rate control system for applying a substance to the vegetation at a variable rate determined in substantially real time based on at least one of the plant spread or the plant density.

20. The apparatus of claim 16, the operations further comprising:
detecting particular echo signals of the plurality of echo signals associated with one or more non-vegetation structures based on at least one of 1) a distance determined based on the particular echo signals or 2) a strength of the particular echo signals; and
removing the particular echo signals from the plurality of echo signals.

21. The apparatus of claim 16, the operations further comprising:
normalizing the plurality of echo signals based on a distance between the one or more transducers and the vegetation.

22. The apparatus of claim 16, wherein the one or more transducers are mounted on an agricultural machine.

23. An agricultural machine comprising:
a transducer mounted on the agricultural machine, the transducer for:
transmitting an ultrasonic signal towards vegetation, and
receiving a plurality of echo signals as reflections of the ultrasonic signal; and
a tree measurement system for:
calculating a plant density of the vegetation based on the plurality of echo signals.

24. The agricultural machine of claim 23, wherein receiving a plurality of echo signals as reflections of the ultrasonic signal comprises receiving the plurality of echo signals within a time window, the tree measurement system further for:
calculating a plant spread of the vegetation based on a first echo signal of the plurality of echo signals received during the time window and a last echo signal of the plurality of echo signals received during the time window.

25. The agricultural machine of claim 24, further comprising:
a variable spray rate control system for applying a substance to the vegetation at a variable rate determined in substantially real time based on at least one of the plant spread or the plant density.
